(19) United States
(12) Patent Application Publication
(10) Pub. No.: US 2004/0179225 A1
(43) Pub. Date: Sep. 16, 2004

(54) System and method for multicast printing

(76) Inventor: Darrell V. Hopp, Lake Forest, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/385,127

(22) Filed: Mar. 10, 2003

(51) Int. Cl. G06F 15/00

(52) U.S. Cl. 358/1.15; 358/1.13

(57) ABSTRACT

This invention is directed to a system and method for multicast image generation. More particularly, this invention is directed to a system and method wherein one I/O port is associated with multiple printers or image generating devices such that one data output operation is simultaneously directed to multiple image generating devices.

### BACKGROUND OF THE INVENTION

This invention is directed to a system and method for multicast image generation. More particularly, this invention is directed to a system and method wherein one I/O port is associated with multiple printers or image generating devices such that one data output operation is simultaneously directed to multiple image generating devices.

By way of background, when a printer is installed on a computer or network, it is first physically connected, that is to say, enabled with a physical data pathway that enables data communication between the network and the printer. Software drivers are then installed on the host machine, which drivers function to allow for communication between an operating system and associated application level programs running thereon. The operating system is thereby configured to communicate to the printer via an I/O port. When data is written to this I/O port, the data is directed to a port monitor that services this type of port. The port monitor checks to determine which printer is attached to the port, and then handles the actual process of connecting and transmitting the data to the printer. If a user wants to send a print job to multiple printers, each printer must be connected to a separate port monitor. The data must be directed to the port monitor for each printer and then each port monitor directs the print job to its associated printer. This increases the time, effort, and cost associated with sending a print job to multiple printers.

There is a need for a system and method for transmitting at least one data output operation to multiple image generating devices simultaneously.

### SUMMARY OF THE INVENTION

In accordance with the present invention, there is provided a system and method for transmitting at least one data output operation to multiple image generating devices simultaneously.

Further, in accordance with the present invention, there is provided a system and method system wherein one I/O port is associated with multiple image generating devices such that one data output operation is simultaneously directed to multiple image generating devices.

Further, in accordance with the present invention, there is provided a system and method which decreases the time, effort, and cost associated with sending a data output operation to multiple image generating devices.

Still further, in accordance with the present invention, there is provided a document reproduction system. The system comprises a memory adapted for storing electronic document data representative of a document and a data input. The data input includes means adapted for receiving a data output command, which data output command includes image generating device selection data representative of at least one of a plurality of image generating devices from which a data output of the document is desired. The system also comprises a data output spooler wherein the data output spooler, a document communication means, and a port monitor. The data output spooler includes means adapted for receiving the electronic document data from the memory after receipt of a data output command. The document communication means communicates a selected portion of the electronic document data from the data output spooler to the port monitor. The port monitor includes means adapted for enabling a data path to each of the at least one of a plurality of image generating devices and means adapted for communicating the selected portion of the electronic document data to the at least one of a plurality of image generating devices. The system further includes means adapted for receiving input from each of the at least one of a plurality of image generating devices to determine a successful transfer of the selected electronic document data to each thereof and testing means adapted for determining whether the entire document has been successfully generated by the at least one of a plurality of image generating devices. Preferably, the image generating devices are printers.

Still further, in accordance with the present invention, there is provided a method for reproducing documents. The method comprises the steps of storing electronic document data representative of a document in a memory, receiving a data output command via data input means, which data output command includes image generating device selection data representative of at least one of a plurality of image generating devices from which a data output of the document is desired, and receiving the electronic document data at a data output spooler from the memory after receipt of a data output command. The method further comprises the steps of enabling a data path by a port monitor to each of the at least one of a plurality of image generating devices, communicating a selected portion of the electronic document data from the data output spooler to the port monitor, and communicating the selected portion of the electronic document data from the port monitor to the at least one of a plurality of image generating devices. The method also comprises the steps of receiving input from each of the at least one of a plurality of image generating devices to determine a successful transfer of the selected electronic document data to each thereof and determining whether the entire document has been successfully generated by the at least one of a plurality of image generating devices.

These and other advantages, aspects, and features will be understood by one of ordinary skill in the art upon reading and understanding the specification.

### BRIEF DESCRIPTION OF THE DRAWINGS

FIG. 1 is a diagram illustrating a preferred embodiment of the system according to the present invention.

FIG. 2 illustrates a block diagram for multicast printing according to the present invention.

FIG. 3 is a sample screen display for selecting at least one port monitor for directing at least one data output operation to multiple image generating devices.

FIG. 4 is a sample screen display for configuring a port monitor.

### DETAILED DESCRIPTION OF THE PREFERRED EMBODIMENT

This invention is directed to a system and method for multicast printing wherein one print operation is simultaneously directed to a plurality of data output devices, such as printers, plotters, facsimile machines, personal digital assistants, or the like. In the preferred embodiment, the output is to a plurality of printers or other suitable hard-copy rendering devices. Although the present invention is described as enabling users to access document management functionality from a Microsoft Windows OS, it will be appreciated to those skilled in the art that the present invention is also suitably designed to interact with any operating system, such as Unix, Linux, Macintosh or other operating system.

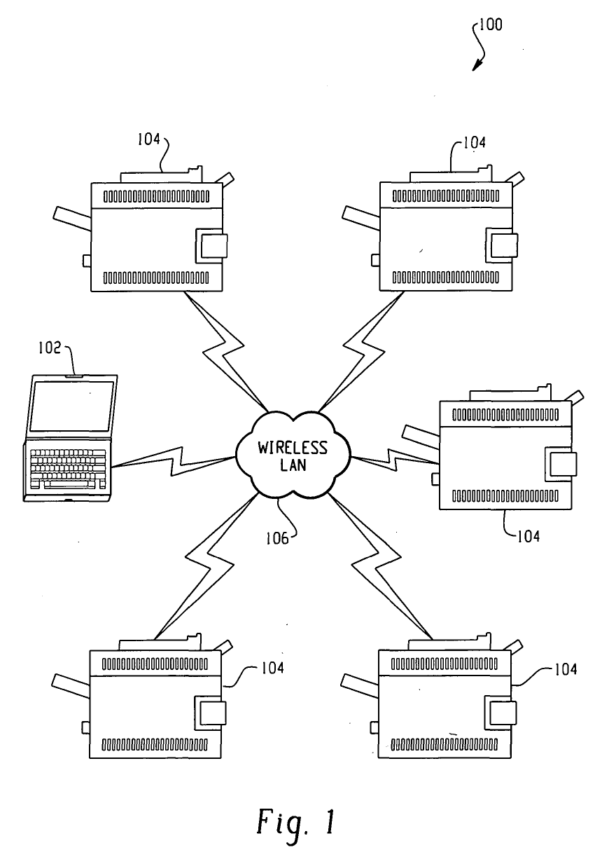

Referring now to FIG. 1, an illustration of a network environment for practicing the present invention is provided. The system comprises a data transport network 100 illustrative of a LAN or WAN environment in which a preferred embodiment is provided, such as a packet-switched TCP/IP-based global communication network. However, it is to be appreciated that any suitable data transport protocol, such as IPX/SPX, among others, is suitable for realizing the subject system. The network 100 is suitably any network and is preferably comprised of physical layers and transport layers, as illustrated by a myriad of conventional data transport mechanisms like Ethernet, Token-Ring™, 802.11x, Bluetooth, or other wire-based or wireless data communication mechanisms as will be apparent to one of ordinary skill in the art.

Connected to data transport network 100 is computer 102. The computer 102 is suitably running on any operating system, such as Windows NT, Windows 2000, Windows XP, Windows 9x, Unix, Linux, Macintosh or other operating system as will be appreciated by one of ordinary skill in the art. A plurality of image generating devices 104 are connected to data transport network 100 via any suitable data transport mechanism 106. The image generating devices are suitably a device such as a printer, facsimile machine, scanning device, copier, multi-function peripheral, or other like peripheral devices. Preferably, the image generating devices are printers. The image generating devices 104 are suitably any networked image generating device as will be appreciated to one of ordinary skill in the art. The image generating device 104 preferably have an internal device controller suitably acting as a fully functional server with suitable hardware and software that ensure proper operation of the image generating device as will be appreciated by those skilled in the art. In addition, the image generating devices 104 preferably comprise internal storage, which is suitably comprised of volatile and/or non-volatile memory, such as hard disk, optical storage media and random access memory (“RAM”) as will be appreciated by those skilled in the art. The invention will be described with particular reference to printers and print jobs. However, one skilled in the art will appreciate that the present invention is designed to interact with any image generating device.

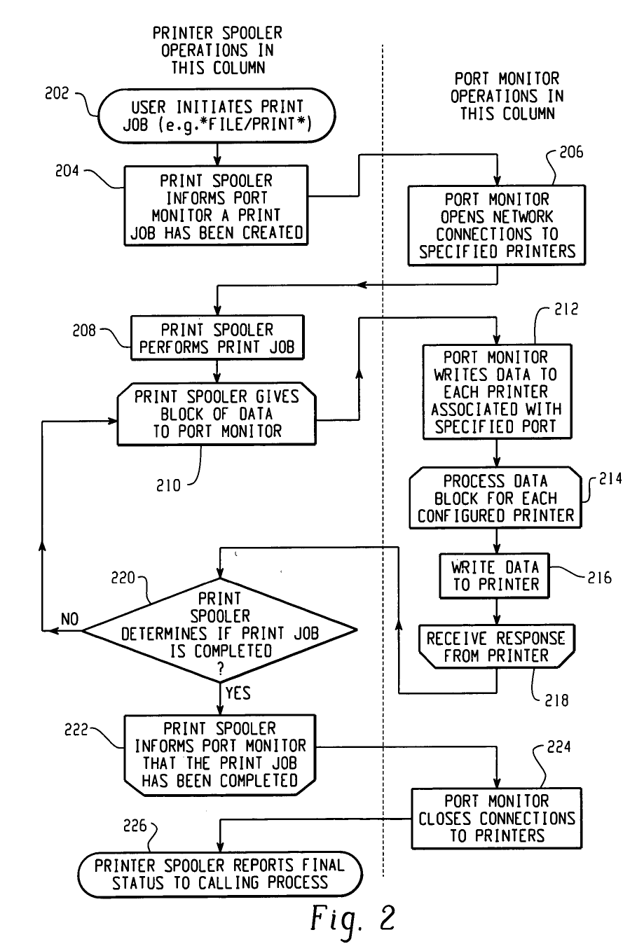

In operation, the user requests a data output or print operation via the computer 102 or other suitable means as shown in FIG. 2 as 202. Preferably, the user selects the parameters for generating the data output by any suitable means. The data output spooler or print spooler informs the port monitor a data output or print job has been created by any suitable means as shown at 204. The port monitor then opens network connections to specified image generating devices or printers by any suitable means as shown at 206.

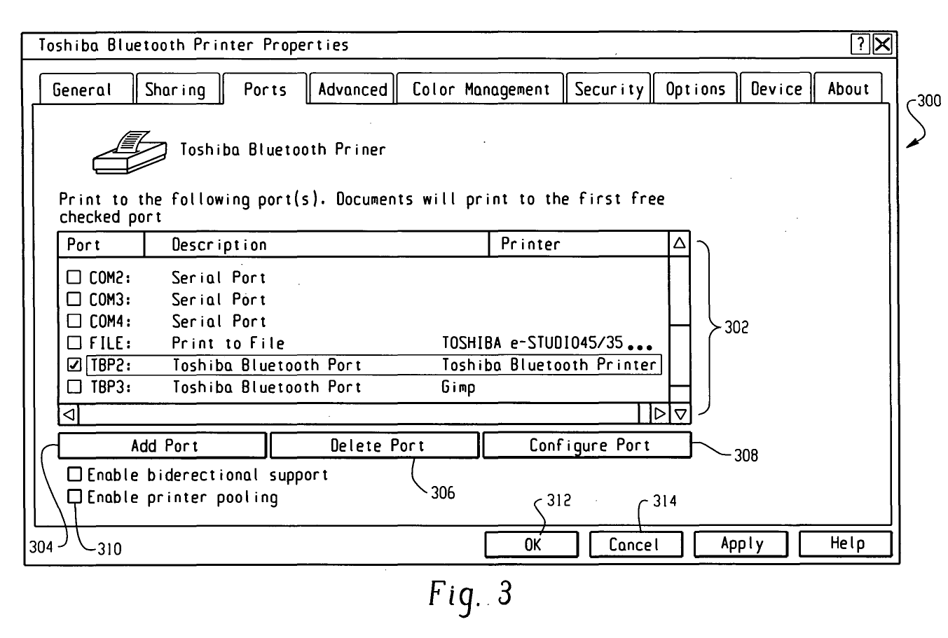

A port monitor provides the link between an I/O port driver and the data output or print spooler. In the preferred embodiment, the print spooler does not read or write directly to a port. The print spooler writes to a port monitor and the port monitor performs the operation on the I/O port for the print spooler. The port monitor maintains a mapping between an I/O port and a list of image generating devices or printers. When a print job is directed to an I/O port instead of sending the print job to one printer, the port monitor simultaneously sends the print job to multiple printers. Preferably, the mapping is configured in a port monitor user interface. A port monitor user interface is any suitable interface known in the art. FIG. 3 is a preferred sample screen display 300 for a port monitor user interface for selecting a port monitor. In region 302, a list of available ports. The user selects the desired port. The user then has the option to add the port by selecting the Add Port button 304, delete the port by selecting the Delete Port button 306, or configure the port by selecting the Configure Port button 308. The user has the option to enable printer pooling by selecting that box 310. The user can select the OK button 312 to save his selections or the Cancel button 314 to cancel the selection.

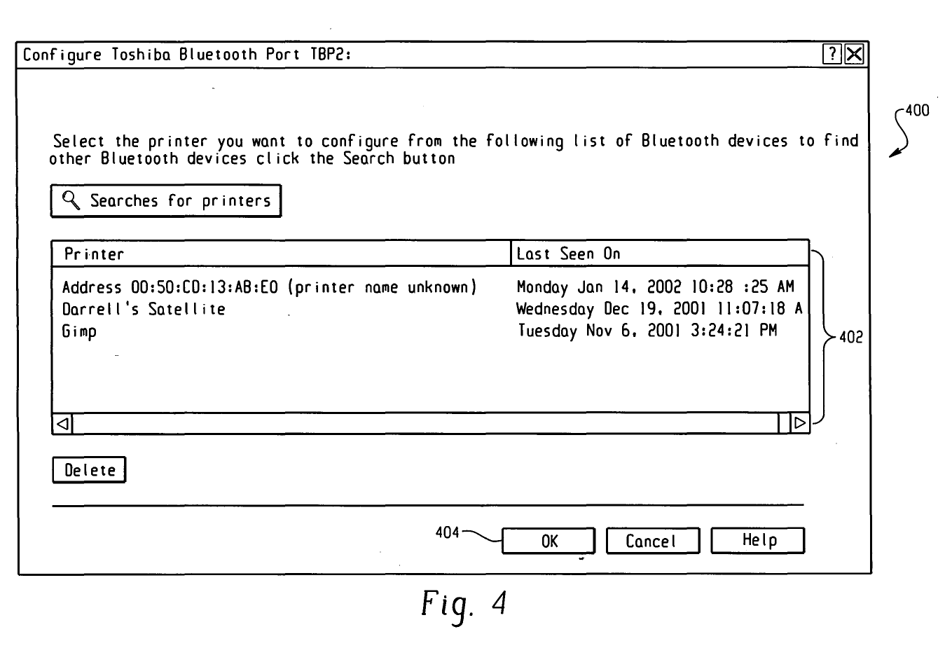

If the user selects the Configure Port option, the user is directed to configure the port to the desired settings. FIG. 4 shows a preferred sample screen display 400 for configure a port. The region 402 displays a list of image generating devices or printers available. The user selects the desired image generating devices to be associated with the port. The user selects the OK button 404 to confirm his selection. Thereafter, whenever a data output or print operation is directed to that port, the port monitor attempts to forward the job to each image generating device or printer selected. The user selects the Cancel button 406 to cancel his selection.

Returning to FIG. 2, once the port monitor has opened the connections to the specified printers, the print spooler performs the print job shown as 208. The print spooler gives a block of data to the port monitor by any suitable means as shown at 210. The port monitor writes data to each printer associated with the specified port by any suitable means as shown at 212. The port monitor processes the data block for each printer associated with specified port by any suitable means as shown at 214. The port monitor writes the data to each printer by any suitable means as shown at 216. The port monitor receives a response from each printer by any suitable means and sends the response to the print spooler as shown by 218. The print spooler then determines if the printjob is completed by any suitable means as shown at 220. If the print job is not completed, the process returns to 210 wherein the print spooler give a block of data to the port monitor. If the print job is completed, the print spooler informs the port monitor that the print job has been completed as shown by 222. The port monitor then closes the connection to the printers as shown at 224. The port monitor then reports the final status by any suitable means as shown at 226.

Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

What is claimed is:

1. A document reproduction system comprising:
a memory adapted for storing electronic document data representative of a document;
a data input, the data input including means adapted for receiving a print command, which print command includes printer selection data representative of at least one of a plurality of printers from which a printout of the document is desired;
a print spooler, the print spooler including means adapted for receiving the electronic document data from the memory after receipt of a print command;
a port monitor, the port monitor including means adapted for enabling a data path to each of the at least one of a plurality of printers as specified by the printer selection data;
a data communication means adapted for communicating a selected portion of the electronic document data from the print spooler to the port monitor;
the port monitor further including means adapted for communicating the selected portion of the electronic document data to the at least one of a plurality of printers as specified by the printer selection data;
means adapted for receiving input from each of the at least one of a plurality of printers as specified by the printer selection data to determine a successful transfer of the selected electronic document data to each thereof; and
testing means adapted for determining whether the entire document has been successfully printed by the at least one of a plurality of printers as specified by the printer selection data.

2. The document reproduction system according to claim 1 further comprising means for iteratively communicating additional, selected portions of the electronic document from the print spooler to the port monitor in accordance with a determination that the entire document has yet to be successfully printed in accordance with the testing means.

3. The document reproduction system according to claim 2 wherein the port monitor includes means adapted for communicating the selected portion of the electronic document data to the at least one of a plurality of printers as specified by the printer selection data via a wireless link.

4. The document reproduction system according to claim 3 wherein the wireless link is an optical link.

5. The document reproduction system according to claim 3 wherein the wireless link is a radio frequency link.

6. The document reproduction system according to claim 1 wherein the port monitor further comprises means adapted to determine which of the plurality of printers is attached to the port monitor.

7. The document reproduction system according to claim 1 wherein the port monitor further comprises means adapted to process the selected portion of the electronic document data for at least one of the plurality of printers prior to communicating the selected portion of the electronic document data to the at least one printer.

8. The document reproduction system according to claim 1 further comprising means adapted for selecting parameters for the data path to at least one of the plurality of printers.

9. The document reproduction system according to claim 1 further comprising means adapted for selecting parameters for printing the document.

10. A method for reproducing documents comprising the steps of:
storing electronic document data representative of a document in a memory;
receiving a print command via data input means, which print command includes printer selection data representative of at least one of a plurality of printers from which a printout of the document is desired;
receiving the electronic document data at a print spooler from the memory after receipt of a print command;
enabling a data path by a port monitor to each of the at least one of a plurality of printers as specified by the printer selection data;
communicating a selected portion of the electronic document data from the print spooler to the port monitor;
communicating the selected portion of the electronic document data from the port monitor to the at least one of a plurality of printers as specified by the printer selection data;
receiving input from each of the at least one of a plurality of printers as specified by the printer selection data to determine a successful transfer of the selected electronic document data to each thereof; and
determining whether the entire document has been successfully printed by the at least one of a plurality of printers as specified by the printer selection data.

11. The method according to claim 10 further comprising the step of iteratively communicating additional, selected portions of the electronic document from the print spooler to the port monitor in accordance with a determination that the entire document has yet to be successfully printed in accordance with the testing means.

12. The method according to claim 11 wherein the selected portion of the electronic document data is communicated to the at least one of a plurality of printers as specified by the printer selection data via a wireless link.

13. The method according to claim 12 wherein the wireless link is an optical link.

14. The method according to claim 12 wherein the wireless link is a radio frequency link.

15. The method according to claim 10 further comprising the step of determining which of the plurality of printers is attached to the port monitor.

16. The method according to claim 10 further comprising the step of processing by the port monitor the selected portion of the electronic document data for at least one of the plurality of printers prior to communicating the selected portion of the electronic document data to the at least one printer.

17. The method according to claim 10 further comprising the step of selecting parameters for the data path to at least one of the plurality of printers.

18. The method according to claim 10 further comprising the step of selecting parameters for printing the document.

19. A document reproduction system comprising:
a memory adapted for storing electronic document data representative of a document;
a data input, the data input including means adapted for receiving a data output command, which data output command includes image generating device selection data representative of at least one of a plurality of image generating devices from which a data output of the document is desired;
a data output spooler, the data output spooler including means adapted for receiving the electronic document data from the memory after receipt of a data output command;
a port monitor, the port monitor including means adapted for enabling a data path to each of the at least one of a plurality of image generating devices as specified by the image generating device selection data;
a data communication means adapted for communicating a selected portion of the electronic document data from the data output spooler to the port monitor;
the port monitor further including means adapted for communicating the selected portion of the electronic document data to the at least one of a plurality of image generating devices as specified by the image generating device selection data;
means adapted for receiving input from each of the at least one of a plurality of image generating devices as specified by the image generating device selection data to determine a successful transfer of the selected electronic document data to each thereof; and
testing means adapted for determining whether the entire document has been successfully generated by the at least one of a plurality of image generating devices as specified by the image generating device selection data.

20. The document reproduction system according to claim 19 further comprising means for iteratively communicating additional, selected portions of the electronic document from the data output spooler to the port monitor in accordance with a determination that the entire document has yet to be successfully generated in accordance with the testing means.

21. The document reproduction system according to claim 20 wherein the port monitor includes means adapted for communicating the selected portion of the electronic document data to the at least one of a plurality of image generating devices as specified by the printer selection data via a wireless link.

22. The document reproduction system according to claim 19 wherein the port monitor further comprises means adapted to determine which of the plurality of image generating devices is attached to the port monitor.

23. The document reproduction system according to claim 19 further comprising means adapted for selecting parameters for the data path to at least one of the plurality of image generating devices.

24. The document reproduction system according to claim 19 further comprising means adapted for selecting parameters for generating the document.

25. A method for reproducing documents comprising the steps of:
storing electronic document data representative of a document in a memory;
receiving a data output command via data input means, which output command includes image generating device selection data representative of at least one of a plurality of image generating devices from which a data output of the document is desired;
receiving the electronic document data at a data output spooler from the memory after receipt of a data output command;
enabling a data path by a port monitor to each of the at least one of a plurality of image generating devices as specified by the image generating devices selection data;
communicating a selected portion of the electronic document data from the data output spooler to the port monitor;
communicating the selected portion of the electronic document data from the port monitor to the at least one of a plurality of image generating devices as specified by the image generating device selection data;
receiving input from each of the at least one of a plurality of image generating devics as specified by the image generating device selection data to determine a successful transfer of the selected electronic document data to each thereof; and
determining whether the entire document has been successfully generated by the at least one of a plurality of image generating devices specified by the image generating device selection data.

26. The method according to claim 25 further comprising the step of iteratively communicating additional, selected portions of the electronic document from the data output spooler to the port monitor in accordance with a determination that the entire document has yet to be successfully generated in accordance with the testing means.

27. The method according to claim 25 wherein the selected portion of the electronic document data is communicated to the at least one of a plurality of image generating devices as specified by the image generating device selection data via a wireless link.

28. The method according to claim 25 further comprising the step of determining which of the plurality of image generating devices is attached to the port monitor.

29. The method according to claim 25 further comprising the step of selecting parameters for the data path to at least one of the plurality of image generating devices.

30. The method according to claim 25 further comprising the step of selecting parameters for generating the document.

31. A computer-readable medium of instruction for reproducing documents comprising:
a memory adapted for storing electronic document data representative of a document;
a data input, the data input including means adapted for receiving a data output command, which data output command includes image generating device selection data representative of at least one of a plurality of image generating devices from which a data output of the document is desired;
a data output spooler, the data output spooler including means adapted for receiving the electronic document data from the memory after receipt of a data output command;
a port monitor, the port monitor including means adapted for enabling a data path to each of the at least one of a plurality of image generating devices as specified by the image generating device selection data;
a data communication means adapted for communicating a selected portion of the electronic document data from the data output spooler to the port monitor;
the port monitor further including means adapted for communicating the selected portion of the electronic document data to the at least one of a plurality of image generating devices as specified by the image generating device selection data;
means adapted for receiving input from each of the at least one of a plurality of image generating devices as specified by the image generating device selection data to determine a successful transfer of the selected electronic document data to each thereof; and
testing means adapted for determining whether the entire document has been successfully generated by the at least one of a plurality of image generating devices as specified by the image generating device selection data.

32. The computer readable medium according to claim 31 further comprising means for iteratively communicating additional, selected portions of the electronic document from the data output spooler to the port monitor in accordance with a determination that the entire document has yet to be successfully generated in accordance with the testing means.

33. The computer readable medium according to claim 32 wherein the port monitor includes means adapted for communicating the selected portion of the electronic document data to the at least one of a plurality of image generating devices as specified by the printer selection data via a wireless link.

34. The computer readable medium according to claim 31 wherein the port monitor further comprises means adapted to determine which of the plurality of image generating devices is attached to the port monitor.

35. A computer implemented method for reproducing documents comprising:
storing electronic document data representative of a document in a memory;
receiving a data output command via data input means, which output command includes image generating device selection data representative of at least one of a plurality of image generating devices from which a data output of the document is desired;
receiving the electronic document data at a data output spooler from the memory after receipt of a data output command;
enabling a data path by a port monitor to each of the at least one of a plurality of image generating devices as specified by the image generating devices selection data;
communicating a selected portion of the electronic document data from the data output spooler to the port monitor;
communicating the selected portion of the electronic document data from the port monitor to the at least one of a plurality of image generating devices as specified by the image generating device selection data;
receiving input from each of the at least one of a plurality of image generating devics as specified by the image generating device selection data to determine a successful transfer of the selected electronic document data to each thereof; and
determining whether the entire document has been successfully generated by the at least one of a plurality of image generating devices specified by the image generating device selection data.

36. The method according to claim 35 further comprising the step of iteratively communicating additional, selected portions of the electronic document from the data output spooler to the port monitor in accordance with a determination that the entire document has yet to be successfully generated in accordance with the testing means.

37. The method according to claim 35 wherein the selected portion of the electronic document data is communicated to the at least one of a plurality of image generating devices as specified by the image generating device selection data via a wireless link.

38. The method according to claim 35 further comprising the step of determining which of the plurality of image generating devices is attached to the port monitor.
